(19) United States
(12) Patent Application Publication
(10) Pub. No.: US 2011/0236684 A1
(43) Pub. Date: Sep. 29, 2011

(54) THERMALLY RESISTANT GLASS FIBERS

(75) Inventors: Roman Teschner, Delitzsch (DE); Kati Richter, Delitzsch OT Pohritzsch (DE); Hans-Peter Richter, Delitzsch OT Pohritzsch (DE)

(73) Assignee: S.D.R. BIOTEC VERFAHRENSTECHNIK GMBH, Neukyhna (DE)

(21) Appl. No.: 12/671,646

(22) PCT Filed: Jul. 29, 2008
(86) PCT No.: PCT/EP08/06233

§ 371 Date: Feb. 1, 2010

(30) Foreign Application Priority Data
Aug. 3, 2007 (DE) 10 2007 036 774.2

(51) Int. Cl. D02G 3/18; D02G 3/36; C03C 13/02; B05D 3/02

(52) U.S. Cl. 428/392; 57/200; 57/240; 501/38; 427/389.8; 427/355

(57) ABSTRACT

A thermally resistant fiber glass includes at least SiO₂, Al₂O₃, and TiO₂.

The strengths of composites, such as hi-tech sandwich building parts, GFRP, vitally depend on the quality of glass and thus of the glass fibers which are used to reinforce composites. The glass fibers highly distinguished from each other in relation to their physico-chemical properties. The more demanding composites are only made from glass fibers which have excellent physico-chemical properties. For the chemical composition of glass fibers refer to Table 1.

TABLE 1
Composition of glass fibers.

| | Oxides in mass % | | | | |
|---|---|---|---|---|---|
| Oxides | E-Glass | R-Glass | ECR-Glass | Advantex ® | S-Glass |
| SiO₂ | 55.0 | 60.0 | 58.4 | 61.0 | 64.7 |
| Al₂O₃ | 14.0 | 24.4 | 11.1 | 13.0 | 25.0 |
| TiO₂ | 0.2 | — | 2.4 | — | — |
| B₂O₃ | 7.0 | — | — | — | — |
| CaO | 22.0 | 9.0 | 21.4 | 22.5 | — |
| MgO | 1.0 | 6.0 | 2.7 | 3.0 | 10.0 |
| ZnO | — | — | 2.7 | — | — |
| Na₂O | 0.5 | 0.5 | 0.8 | — | 0.3 |
| K₂O | 0.3 | 0.1 | 0.1 | 0.5 | — |

E-Glass (E=Elecric) is aluminum borosilicate glass which contains a small portion of alkali oxides (<2 mass %) and has good electric insulating properties.

E-glass fibers are specially suited for manufacturing printed circuit boards and reinforce plastics. The thermal resistance of E-glass (as defined by the transformation temperature) is however unsatisfactory, being under 680 degrees Celsius.

One large disadvantage of E-glasses is their low acid resistance (acid resistance class 4). Such E-glasses are described in patent specifications like U.S. Pat. No. 3,876,481; U.S. Pat. No. 3,847,627; U.S. Pat. No. 2,334,961; U.S. Pat. No. 2,571,074; U.S. Pat. No. 4,026,715; U.S. Pat. No. 3,929,497; U.S. Pat. No. 5,702,498; EP 0 761 619 A1; U.S. Pat. No. 4,199,364 and in U.S. Pat. No. 3,095,311.

R-glass (R=Resistance) is a lime silicate aluminum silicate glass, the transformation temperature and softening point of which are 730 degrees Celsius and 950 degrees Celsius respectively. Similar glasses, such as the “Supremax” glass may be used as thermometer glass in view of their low expansion coefficient.

R-glass fibers have been used in all areas of application requiring high mechanic and thermal demands. R-glass fibers have rather high tension strength, even at high temperatures.

ECR-glass (ECR=E-Glass Corrosion Resistance), such as the one described in DE 69607614 T2, is a boron-free aluminum lime silicate glass with a low percentage of alkali oxides. ECR glass fibers have high acid resistance and good mechanical and electrical qualities. They have been used for more demanding plastic reinforcement tasks.

Advantex® glass, as described in U.S. Pat. No. 5,789,329, is a modified ECR glass with a very low content of alkali oxides and improved physico-chemical properties. Long-term temperature resistance of this kind of fiber is of approx. 740 degrees Celsius.

S-glass (S=Strength) is a magnesium aluminum silicate glass. It was developed as a special glass for high mechanical requirements, for high temperatures in particular, (such as in WO 02/042233 A3) and contains more than 10 Mol % of Al₂O₃.

Other high temperature glasses are described in U.S. Pat. No. 2,571,074 in U.S. Pat. No. 3,847,627 and in U.S. Pat. No. 4,542,106, among others.

For the properties of the best types of glass fiber as compared to those of E-glass refer to Table. 2.

TABLE 2
Properties of selected glass fibers

| | Glass Fibers | | | | |
|---|---|---|---|---|---|
| | | | ECR- | | |
| Properties | E-Glass | R-Glass | Glass | Advantex ® | S-Glass |
| Density | 2620 | 2550 | 2670 | 2620 | 2480 |
| [kg/m³] | | | | | |
| Expansion | 5.4 · | 4.1 · | 5.9 · 10⁻⁶ | 6.0 · 10⁻⁶ | 2.0 · 10⁻⁶ |
| coefficient | 10⁻⁶ | 10⁻⁶ | | | |
| [K⁻¹] | | | | | |
| Viscosity: | | | | | |
| Softening point | 850 | 950 | 880 | 915 | 1050 |
| [° C.] | | | | | |
| Tensile | 3450 | 3400 | 3450 | 3500 | 4890 |
| strength [MPa] | | | | | |
| E-Module | 72.0 | 85.0 | 72.0 | 81.0 | 87.0 |
| [GPa] | | | | | |
| Elongation [%] | 4.8 | 4.6 | 4.8 | 4.6 | 5.7 |
| Permittivity | 6.6 | 6.0 | 6.9 | 6.8 | 5.3 |
| at 1 MHz | | | | | |

You can see from Table 2 that the S-glass fibers have the best mechanical properties. These fibers also have a chemical and thermal resistance which is very good.

The traditional S-glass is a magnesium aluminum silicate glass which was developed for high mechanical demands, at higher temperatures in particular.

The glasses of the MgO—Al₂O₃—SiO₂ ternary system will easily solidify, but they tend to crystallize and phase separation when treated thermally afterwards.

If you subject S-glasses to thermal treatment, the result will be the separation of a silicate glass droplet phase rich in MgO and Al₂O₃ and finally crystallization. This means a great disadvantage of the traditional S-glass and all products made from it.

The ternary MgO—Al₂O₃—SiO₂ system may lead to the crystallization of mullite 3Al₂O₃.2SiO₂, forsterite 2MgO.SiO₂, spinel MgO.Al₂O₃, cordierite 2MgO.2Al₂O₃.5SiO₂ and periclase MgO and others.

Both the phase separation and the crystallization will lead to a heavy decrease of strength of the fibers, their embrittlement and destruction (cross fragmentation). The fiber resistance as to temperature changes is neither satisfactory. Another great disadvantage is the relative high purchase price of the S-glass fibers. Such a type of fiber will for the rest only be used reasonably in a small number of applications.

Another kind of fiber used for more demanding plastic reinforcement tasks is a glass fiber made of the boron-free Advantex® glass.

When comparing them with S-glass, Advantex® glass fibers have lower strengths and lower thermal resistance, but their tendency to crystallize is relatively rather low.

To produce glass fibers, the glass is melted in the melting furnace in a specified composition of mixture. The molten glass is then fed to the bushings by means of a throat and a feeder.

A bushing, which is regularly made of a precious-metal alloy (mainly Pt/Rh alloy), represents one fiberising unit in which the spinning process proper takes place. A bushing is provided with multiple tips which are used to draw singular filaments and bundling some of them if applicable.

Naturally, the quality of the molten glass will be of vital importance for the spinning process. You may only process a fully homogeneous molten mass, presenting no flaws from glass production, in the fiber-drawing process. Any presence of small stones, plaster etc. inside the molten mass affects the spinning process negatively or totally destroys it as many fibers will be broken in their hot condition.

Spinning processes can only be carried out within a specified range of temperatures (between the so-called upper and lower temperature limits), the optimum stability of the spinning process being reached at log η≈3.0 (η in dPas).

Around the lower temperature limit, the mass flow in the tips will decrease the more viscosity increases. Tensions inside the drawing bulb which are caused by the enormous drawing force will strongly increase. Due to the high tensile force during fiber-drawing around the lower temperature limit, previous deformations and weak points inside the network are “frozen” in the filaments. This will lead to a strong decrease of fiber strength and the subsequent deterioration of the spinning process in particular. The high force of fiber-drawing, in combination with a highly-viscous molten glass mass and the hydraulic pressure of the mass in the bushing can lead to the deformation of the tip base. When fibers are drawn around the lower temperature limit, the process of restarting spinning after hot breakages may take a little longer, thus affecting the degree of efficiency of glass-fiber production.

If the spinning process is carried out at around the upper temperature limit, the rim of the tips (tip face) is intensively moistened, thus producing a certain “dead zone” inside the drawing bulb and subsequently longer duration of stay of the molten mass, which may lead to germ formation. The higher the drawing process temperature, the larger the drawing bulb and longer the period of cooling, thus facilitating the attacks of particles of dust, water steam and reactive gases. The result is a decrease of strength, especially if the spinning process is performed at high air humidity.

When fibers are drawn at around or beyond the upper temperature limit, the spinning process will be destabilized. Small disturbances on the drawing drum (vibrations or oscillations, for instance) have been seen to cause oscillations of the drawing bulb, which may lead to a rapid hot breakage of the fiber. Any increase of glass surface tension will have a stabilizing effect on the spinning process, thus enabling you to increase the drawing speed as compared to a glass with lower surface tension. You may also influence the surface tension of the molten glass by changing the glass composition.

During the technological process of glass-fiber production, fiber cooling is of the essence, among other things. The drawn-out glass fiber must be quickly cooled down to a temperature below that of glass transformation over a length of approx. 30 mm. Cooling temperature may amount to approx. 200 degrees Celsius per cm (20000° C./m) or ca. 1000° C./ms.

The faster and more intense the cooling phase, the easier the glassy condition can be “frozen” and the better will be the final mechanical properties of the fibers. Furthermore, the glass fibers drawn must be intensely cooled down in the area of the drawing bulb and below it, using cooling combs (fin-coolers) or cooling tubes to intensify the glass fiber cooling process, additional water jet nozzles are sometimes installed below the bushing. The water sprayed on the glass filaments has not only the purpose of cooling, but the reduction of static charging of the fibers as well.

Indirect melt procedures are often assisted by spinning aids (agents like glycols or polyglycols), which are directed into the drawing bulb and fiber forming area in its gaseous condition. In addition to fiber cooling, the spinning aid also helps increase surface tension on the drawing bulb, eliminating or strongly reducing the static charges formed on the filaments and providing the first protection of the virgin glass surface. Any insufficient and/or uneven fiber cooling affects the running properties of the bushing and therefore the quality of the glass fibers drawn.

The invention is based on the task of developing new textile glass fibers to be offered to the market, which do not have the flaws of the known textile fibers and which moreover have excellent thermal stability. Such a new kind of fiber must not have any tendency of crystallization due to long-term temperature treatment which would affect its mechanical properties. At the same time, it is intended to heavily cut down on the glass fiber production costs, as compared to those of similar types of fiber, without reducing however the physico-chemical properties of the glass.

The new type of fiber should moreover increase the efficiency of glass fiber production in industrial serial production.

It is also the purpose of the invention to develop new fibers which will not only present excellent physico-chemical properties, but also contribute to essentially improve the mechanical properties of the composite materials produced using these new fibers. The glass fibers should have both a low density and high tensile strength and elongation. The new fibers should be highly resistant against temperature changes and highly withstand bending.

In particular, thermal resistance of the glass filaments should amount to more than 750 degrees Celsius.

The glass used to make the fibers should have the following chemical resistance:

| | |
|---|---|
| Hydrolytic resistance | Class 1 (<0.1 cm³ 0.01N HCl) |
| Acid resistance | Class 1 (<0.7 mg/dm²) |
| Base resistance | ≦Class 2 (<175 mg/dm²). |

The purpose of the invention is fulfilled by the characteristics of claim 1.

The subclaims 2 to 8 represent advantageous embodiments of the thermally resistant glass fibers of the invention which are described here as examples without limitation.

The glass properties which a thermally resistant glass fibers within the meaning of the invention are especially the following ones:
high chemical strength:

| | |
|---|---|
| Hydrolytic resistance | Class 1 (<0.1 cm³ 0.01N HCl) |
| Acid resistance | Class 1 (<0.7 mg/dm²) |
| Base resistance | ≦Class 2 (<175 mg/dm²). |

thermal resistance, in particular a temperature resistance >750° C.,
low tensile strength losses of especially <50%, due to a temperature of particularly >750° C. over a minimum of 24 hours,
good dielectric properties, namely a permittivity of max. 6.5 at 1 MHz,
high resistance against temperature changes, namely at least no cross fragmentation of the 10-μm fiber during cooling down to ambient temperature from 300° C.

It has surprisingly become apparent during the great number of tests and trials that especially the glass fiber properties which are required as described above can be achieved if the fibers are made of glass of the following composition:

| | | |
|---|---|---|
| SiO₂ | 62.0 to 66.0 | mass % |
| Al₂O₃ | 14.0 to 16.4 | mass % |
| TiO₂ | 0.8 to 1.2 | mass % |
| CaO | 10.0 to 12.0 | mass % |
| MgO | 4.0 to 6.0 | mass % |
| ZnO | 0.8 to 1.5 | mass % |
| Na₂O + K₂O + Li₂O | 0.2 to 0.6 | mass % |
| CeO₂ | 0.2 to 0.5 | mass % |
| TeO₂ + HfO₂ + La₂O₃ | less than 0.5 | mass %. |

Such a glass composition offers specifically good physico-chemical glass fiber properties.

According to a preferred design of the glass of the invention, the latter has the following composition:

| | | |
|---|---|---|
| SiO₂ | 64.6 | mass % |
| Al₂O₃ | 16.0 | mass % |
| TiO₂ | 1.0 | mass % |
| Fe₂O₃ | 0.1 | mass % |
| CaO | 11.2 | mass % |
| MgO | 4.8 | mass % |
| ZnO | 1.2 | mass % |
| Na₂O + K₂O + Li₂O | 0.5 | mass % |
| CeO₂ | 0.3 | mass % |
| TeO₂ + HfO₂ + La₂O₃ | 0.3 | mass %. |

The purpose of the invention is furthermore fulfilled with a procedure to treat the thermally resistant glass fiber of the invention with a size, characterized in claim 9.

The subclaims 10 to 12 represent advantageous embodiments of the thermally resistant glass fibers of the invention which are described here as examples without limitation.

The purpose of the invention is furthermore fulfilled through a size-treated glass fiber according to the characteristics of claim 13.

### EXAMPLE 1

In a laboratory melting appliance, a glass of the following composition was produced:

| | | |
|---|---|---|
| SiO₂ | 64.6 | mass % |
| Al₂O₃ | 16.0 | mass % |
| TiO₂ | 1.0 | mass % |
| Fe₂O₃ | 0.1 | mass % |
| CaO | 11.2 | mass % |
| MgO | 4.8 | mass % |
| ZnO | 1.2 | mass % |
| Na₂O + K₂O + Li₂O | 0.5 | mass % |
| CeO₂ | 0.3 | mass % |
| TeO₂ + HfO₂ + La₂O₃ | 0.3 | mass %. |

The transformation temperature of the new glass was of 770 degrees Celsius and its softening temperature of 972° C. The fiberising point, defined as log η=3 (η-viscosity in dPas) was of ca. 1400° C. The roving fibers drawn from the molten mass and treated with the size of the invention had a tensile strength of singular filaments of 4000 MPa.

When the new type of fiber was put to the test, it was surprisingly found that the fibers made of the glass composition of the invention, when compared to generally known high-temperature fibers, such as R-glass, ECR-glass, Advantex glass fibers, had an excellent stress-strain behavior. The elongation of the fibers of the invention was of 5%.

Fibers produced with this glass should be treated with a spezial sizing agent in order to develop their excellent physico-chemical properties once they are composed with resins to form composites. Only the glass fibers which are compatible with teh polymer matrix will ensure that the reinforced plastic (GFRP) will have excellent physico-chemical properties.

Multiple tests have made evident that the excellent physico-chemical properties of the fibers and the composites made with their use are particularly developed if the fibers of the invention are treated with a size for roving fiber manufacturing, consisting of:
a) 2.0-4.0 mass % of polyvinylacetate ethylene copolymer
b) 0.3-0.7 mass % of polyamidoamide
c) 0.1-0.3 mass % of polyvinyl alcohol polyether mixture
d) 0.1-0.3 mass % of polyolefine wax
e) 0.4-0.7 mass % of coupling agent, and
f) water as the balance to 100 mass %.

These properties include in particular:

### Concerning the Fiber:

| | |
|---|---|
| Tensile strength: | 4000 MPa |
| Elongation: | 5% (+/−0.2%) |
| Tensile strength losses after 24 h at 600° C. | 50% |
| E-Module: | 84 MPa |

### Concerning the Composite Containing Polyester:

| | |
|---|---|
| Tensile strength as compared to E-glass: | ca. + 10% |
| After 3 days of exposition in boiling water, | ca. + 6%. |
| as compared to E-glass: | |

The glass fibers so sized have excellent integrity, elasticity and a very good tensile strength (ca. 4000 MPa) as well as excellent elongation (5%) when comparing them to similar types of fibers, such as R-glass or Advantex® glass. During the weaving process, the new fibers ensure the excellent antislip quality and cuttability of warp and weft. Due to their specifically good compatibility the composites produced with these fibers have excellent strength values.

For epoxy resin systems (epoxy resin matrix) you may use a sizing (PF1) of the following chemical composition when you treat the glass fibers:

Sizing PF1

| | |
|---|---|
| 1.) CH₃COOH (60%) | 0.25 mass % |
| 2.) Appretan 3588 (55%) | 3.00 mass % |
| 3.) Albosize GL (12.5%) | 1.60 mass % |
| 4.) Arkofil CS (20%) | 1.00 mass % |
| 5.) Polypropylene wax PP-W (30%) | 0.40 mass % |
| 6.) A1100 | 0.50 mass % |
| 7.) Water | 93.25 mass % |

Use the formula below to mix the sizing:

### Mixing Process Method for 100 Kg

1.) 60 kg water+240 g acetic acid [CH₃COOH (60%)] are used as receiver.
2.) 0.5 kg γ-methacryloxypropyltrimethoxysilane (A-1100) is hydrolyzed with 5.0 kg de-ionized water+10 g [CH₃COOH (60%)]. Duration of hydrolysis approx. 15 min.
3.) Add hydrolyzate solution A-1100.

4.) 3.0 kg vinylacetatethylencopolymer [Appretan 3588 (55%)], stirred up with 10 kg water is added to the preparation.
5.) 1.6 kg polyamidoamide [Albosize GL (12.5%)] is added to the preparation.
6.) 1.0 kg polyvinyl alcohol polyether [Arkofil CS (20%)] is thinned with 6.0 kg water and added to the preparation.
7.) 0.4 kg polypropylene wax dispersion PP-W (30%) is added to the preparation.
8.) Add the remaining water (12.25 kg)+1-2 g of the antifoaming agent (Surfynol 440).
9.) Stir up the size and determine the pH-value.

For unsaturated polyester resins, you may, for instance, use a sizing (PF12) of the following composition:

Sizing PF12

| | |
|---|---|
| 1.) CH₃COOH (60%) | 0.20 mass % |
| 2.) Appretan 3588 (55%) | 2.80 mass % |
| 3.) Albosize GL (12.5%) | 2.00 mass % |
| 4.) Arkofil CS20 (20%) | 2.00 mass % |
| 5.) Wax Michem 42035 (35%) | 0.30 mass % |
| 6.) A 174 | 0.50 mass % |
| 7.) Water | 92.20 mass %. |

Use the formula below to mix the sizing:

### Mixing Process Method for 100 Kg

1. 55 kg water+180 g CH₃COOH (60%) are used as receiver.
2. 0.5 kg γ-methacryloxypropyltrimethoxysilane (A 174)+20 g CH₃COOH (60%) are hydrolyzed with 3.5 kg hot de-ionized water. Duration of hydrolysis approx. 20 min.
3. Add hydrolyzate solution A 174.
4. 2.8 kg polyvinylacetate ethylene dispersion (Appretan 3588-55%), stirred up with 10 kg water is added to the preparation.
5. 2.0 kg polyvinyl alcohol polyether (Arkofil CS20-20%) is added to the preparation.
6. 2.0 kg polyamidoamide (Albosize) is added to the preparation.
7. 0.3 kg polyolefin wax (Michem 42035) is added to the preparation.
8. Add the remaining water (23.7 kg)+ca. 1 g antifoaming agent [Surfynol 440].
9. Stir up the size and determine the pH-value.

The sizes with a solid-state concentration of approx. 2.8 mass % ensure excellent fiber wetting by improving the affinity with the plastic matrix, thus being vital for a very good strength of the final product (composite).

### EXAMPLE 2

In the laboratory, a glass of the composition below was molten:

| | |
|---|---|
| SiO₂ | 65.0 mass % |
| Al₂O₃ | 15.6 mass % |
| TiO₂ | 1.0 mass % |
| Fe₂O₃ | 0.1 mass % |
| CaO | 11.0 mass % |
| MgO | 5.0 mass % |
| ZnO | 1.0 mass % |
| Na₂O + K₂O + Li₂O | 0.5 mass % |
| CeO₂ | 0.4 mass % |
| TeO₂ + HfO₂ + La₂O₃ | 0.4 mass %. |

The most important fix points of the above glass of the invention are:

| | |
|---|---|
| Transformation temperature | 768° C. |
| Softening point | 970° C. |
| Fiberising temperature | 1400° C. |

Fiberising Point (log η=3)=Fiberising temperature=temperature where fibers are formed.

The hydrolytic resistance of the glass is 0.03 cm³ 0.01N HCl, classified by Class 2. Acid resistance (with a release of less than 0.7 mg/dm²) of the glass is also in Class 1. Base resistance (with a material consumption of 102 mg/dm²) corresponds to Class 2. The filaments drawn from this glass, of a diameter of 10 μm, have a tensile strength of 3800 MPa. The elongation determined in this tensile test was of 5%.

The filaments were coated with the sizing PF1.

### EXAMPLE 3

In a laboratory melting appliance, a glass of the invention with the following composition was produced:

| | |
|---|---|
| SiO₂ | 64.2 mass % |
| Al₂O₃ | 16.2 mass % |
| TiO₂ | 1.0 mass % |
| Fe₂O₃ | 0.1 mass % |
| CaO | 11.6 mass % |
| MgO | 4.6 mass % |
| ZnO | 1.2 mass % |
| Na₂O + K₂O + Li₂O | 0.5 mass % |
| CeO₂ | 0.3 mass % |
| TeO₂ + HfO₂ + La₂O₃ | 0.3 mass %. |

The glass had the following fix points:

| | |
|---|---|
| Transformation temperature | 775° C. |
| Softening point | 975° C. |
| Fiberising temperature | 1390° C. |

The hydrolytic resistance of the glass is 0.05 cm³ 0.01N HCl, classified by Class 1 (in accordance with DIN ISO 719). Acid resistance (of a value of less than 0.7 mg/dm² and/or alkali release of 10 μg/dm²) is also in Class 1. The base resistance determined (with a material consumption of 100 mg/dm²) puts the glass in Resistance Class 2.

Glass fibers were then drawn from the glass of the invention and coated during the drawing process. The sizing used was PF12.

Fiber diameter was 10 μm. The tensile strength of the singular filaments was found to be 4200 MPa. Elongation was 5.0%.

1-14. (canceled)

15. A thermally resistant glass fiber, comprising the following glass fiber components:

| | | |
|---|---|---|
| 62.0 to 66.0 | mass % | SiO₂ |
| 14.0 to 16.4 | mass % | Al₂O₃ |
| 0.8 to 1.2 | mass % | TiO₂ |
| 10.0 to 12.0 | mass % | CaO |
| 4.0 to 6.0 | mass % | MgO |
| 0.8 to 1.5 | mass % | ZnO |
| 0.2 to 0.6 | mass % | Na₂O + K₂O + Li₂O |
| 0.2 to 0.5 | mass % | CeO₂ |
| a content of less than 0.5 | mass % | TeO₂ + HfO₂ + La₂O₃ |

all glass fiber components adding up to 100 mass %.

16. The glass fiber according to claim 15, wherein a content of Al₂O₃ is less than 16.5 Mol %.

17. The glass fiber according to claim 15, which comprises the following components:

| | |
|---|---|
| 64.6 mass % | SiO₂ |
| 16.0 mass % | Al₂O₃ |
| 1.0 mass % | TiO₂ |
| 0.1 mass % | Fe₂O₃ |
| 11.2 mass % | CaO |
| 4.8 mass % | MgO |
| 1.2 mass % | ZnO |
| 0.5 mass % | Na₂O + K₂O + Li₂O |
| 0.3 mass % | CeO₂ |
| 0.3 mass % | TeO₂ + HfO₂ + La₂O₃ |

18. The glass fiber according to claim 15, wherein a mass ratio of CeO₂ to TeO₂+HfO₂+La₂O₃ is 1:1.

19. The glass fiber according to claim 15, wherein a mass ratio of ZnO to CeO₂ ranges between 2:1 and 6:1 (ZnO:CeO₂=2:1 to 6:1).

20. The glass fiber according to claim 15, wherein a percentage of Li₂O is less than 0.25 mass %.

21. The glass fiber according to claim 15, having a minimum chemical resistance below the following:

| | |
|---|---|
| hydrolytic resistance | Cl.1 (<0.1 cm³ 0.01N HCl) |
| acid resistance | Cl.1 (<0.7 mg/dm²) |
| base resistance | ≦Cl.2 (<175 mg/dm²). |

22. The glass fiber according to claim 15, configured to be treated with an aqueous size comprising a solid material portion of between 2.0 and 3.0 mass %, consisting of:
a) 2.0-4.0 mass % of polyvinylacetate ethylene copolymer
b) 0.3-0.7 mass % of polyamidoamide
c) 0.1-0.3 mass % of polyvinyl alcohol polyether mixture
d) 0.1-0.3 mass % of polyolefin wax
e) 0.4-0.7 mass % of coupling agent, and
remainder water to balance to 100 mass %.

23. A process of treating a glass fiber, which comprises:
providing a glass fiber according to claim 15;
treating the glass fiber with an aqueous size comprising a solid material content of between 2.0 and 3.0 mass %, consisting of:
a) 2.0-4.0 mass % of polyvinylacetate ethylene copolymer;
b) 0.3-0.7 mass % of polyamidoamide;
c) 0.1-0.3 mass % of polyvinyl alcohol polyether mixture;
d) 0.1-0.3 mass % of polyolefin wax;
e) 0.4-0.7 mass % of coupling agent; and
water as the balance to 100 mass %; and
subsequently subjecting the glass fiber to a thermal treatment.

24. The process according to claim 23, which comprises applying the aqueous size to a glass surface with an applicator, and performing the subsequent thermal treatment in a compartment drier or a high-frequency drier after a minimum relaxation period of 24 hours.

25. The process according to claim 24, wherein the applicator is a galette or a cushion applicator.

26. The process according to claim 23, which comprises performing the thermal treatment in a compartment drier or high-frequency drier at temperatures ranging from 100 to 180° C.

27. The process according to claim 23, which comprises treating the glass fiber to result in a loss on ignition (LOI) of 0.2 to 0.8 mass % after thermal treatment.

28. Size-treated glass fibers produced by the process according to claim 23.

29. Rovings, comprising size-treated glass fibers treated by the process according to claim 23.

30. Single or ply yarns, comprising size-treated glass fibers treated by the process according to claim 23.
